(19) United States
(12) Patent Application Publication
(10) Pub. No.: US 2025/0162246 A1
(43) Pub. Date: May 22, 2025

(54) POWDER BED RECOATERS INCLUDING NON-CONTACT POWDER REDISTRIBUTORS

(71) Applicant: Powder Motion Labs, LLC, Arvada, CO (US)

(72) Inventors: Connor L. COWARD, Arvada, CO (US); Maxwell MULHOLLAND, Wheat Ridge, CO (US)

(21) Appl. No.: 19/032,315

(22) Filed: Jan. 20, 2025

Related U.S. Application Data
(63) Continuation of application No. PCT/US2023/027826, filed on Jul. 14, 2023.
(60) Provisional application No. 63/391,572, filed on Jul. 22, 2022.

(51) Int. Cl. B29C 64/205; B05C 19/00; B33Y 30/00

(52) U.S. Cl. CPC B29C 64/205; B05C 19/002; B33Y 30/00

(57) ABSTRACT

Exemplary embodiments are disclosed of powder bed recoaters including non-contact powder redistributors. Also disclosed are exemplary embodiments of powder bed additive manufacturing systems including non-contact powder redistributors and methods for recoating powder beds. In an exemplary embodiment, a method comprises applying powder in a pattern along a top surface of a powder bed such that the applied powder covers only one or more portions, and not the entirety, of the powder bed. The method further comprises redistributing the powder in the pattern to flatten or level the powder bed without physically contacting the powder bed.

### CROSS-REFERENCE TO RELATED APPLICATIONS

This application is a continuation of PCT International Application No. PCT/US2023/027826 filed Jul. 14, 2023 (published as WO2024/019944 on Jan. 25, 2024), which claims priority to and the benefit of U.S. Provisional Patent Application No. 63/391,572 filed Jul. 22, 2022

This application is related to:
(1) U.S. Pat. No. 11,872,754 issued Jan. 16, 2024;
(2) U.S. Pat. No. 11,607,846 issued Mar. 21, 2023;
(3) U.S. Pat. No. 11,407,172 issued Aug. 9, 2022;
(4) U.S. Pat. No. 11,772,164 issued October 3, 2023;
(5) U.S. Pat. No. 11,612,940 issued Mar. 28, 2023; and
(6) U.S. Pat. No. 11,273,598 issued Mar. 15, 2022,

The entire disclosures of the above patent applications and patents are incorporated herein by reference.

### FIELD

The present disclosure relates generally to powder leveling devices and more specifically relates to powder bed recoaters including non-contact powder redistributors.

### BACKGROUND

This section provides background information related to the present disclosure which is not necessarily prior art.

Powder bed-based 3D printing technologies include Powder Bed Fusion (PBF) and Binder Jetting. In PBF, 3D parts are formed layer by layer using a heat source such as a laser or electron beam to selectively fuse particles in a powder bed.

More specifically, the PBF processes begin with a solid substrate. A thin layer of powder is then spread across the substrate. A heat source (e.g., laser or electron beam, etc.) above the substrate scans a pattern corresponding to the cross section of the part, selectively melting the powder, and fusing to the substrate below.

For each subsequent layer, the substrate is lowered and more powder is spread across the top of the substrate. The heat source then scans the next layer of the part, fusing the new powder together with the previous layer.

FIG. 1 illustrates a conventional powder bed fusion process. A very smooth, even layer of powder needs to be spread over the build plate for Powder Bed Fusion. This is usually accomplished by dosing enough powder for each layer from a powder source reservoir and then spreading the powder flat with a scraper or roller. During each layer, the build plate is lowered by one layer height thereby leaving a gap between the bottom of the scraper and the top of the previous layer. As the scraper is moved over the build plate, the scraper spreads powder into the gap to cover the previous layer. Typically, a small amount of excess powder is used for each layer to ensure full build-plate coverage. Excess powder is sometimes collected in a third reservoir beyond the build plate.

Alternatively, a roller may be used instead of a scraper. A roller is a counter-rotating drum that spreads powder onto the build plate. Rollers are said to provide more powder compaction, which leads to higher part density and strength.

### DRAWINGS

The drawings described herein are for illustrative purposes only of selected embodiments and not all possible implementations, and are not intended to limit the scope of the present disclosure.

FIG. 1 illustrates a conventional powder bed fusion process.

FIG. 2 is an image of a wiper fail causing part defects. Vertical lines indicate where the wiper has been damaged and is leaving streaks in the powder bed. This type of failure is very common.

FIG. 3 illustrates how protrusions in a recently fused part can collide with the recoater blade.

FIG. 4 illustrates how “flinging” can occur where a thin part will throw or fling powder after being struck by the recoater.

FIG. 5 illustrates an example of electrostatic powder leveling.

FIG. 6 illustrates the electrostatic powder leveling example shown in FIG. 5 after a part has warped above the powder bed level.

FIG. 7 illustrates an example process in which an electrode with an alternating electric field is used to create a level bed of powder.

FIG. 8 illustrates an example process in which a wiper (e.g., a compliant or flexible wiper, etc.) is used to pre-spread powder onto the bed and then an electrode with an alternating electric field is used to correct defects left by the wiper and thereby create a level bed of powder.

FIGS. 9 and 10 respectively show powder patterns before and after spreading or redistributing the powder in the powder bed via a non-contact powder redistributor (e.g., including an electrode with alternating electric field, gas jets, ultrasonic vibration, etc.) according to exemplary embodiments of the present disclosure.

FIGS. 11 and 12 illustrate a recoating cycle according to an exemplary embodiment of the present disclosure.

FIG. 13 illustrates a powder bed recoater including a non-contact powder redistributor comprising an electrode according to an exemplary embodiment of the present disclosure. The non-contact powder redistributor is configured to create an alternating electric field between the electrode and the powder bed for causing powder particles to redistribute from high spots to low spots to thereby flatten the powder bed.

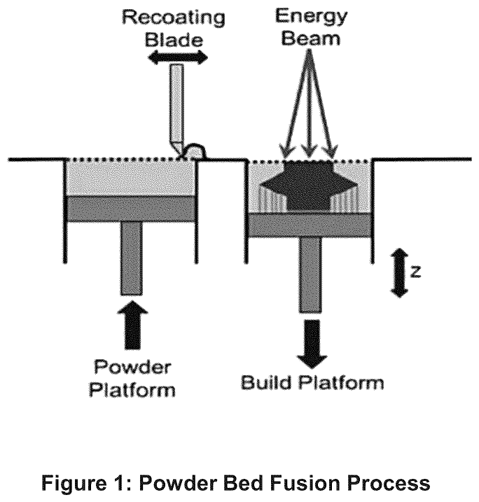

Corresponding reference numerals may indicate corresponding (though not necessarily identical) parts throughout the several views of the drawings.

### DETAILED DESCRIPTION

Example embodiments will now be described more fully with reference to the accompanying drawings.

### Recoater Problems in Powder Bed Fusion (PBF)

As recognized herein, recoater problems exist with Powder Bed Fusion (PBF) processes. As parts are being built during selective laser melting (SLM), very often the parts will warp and twist as sections of the part are heated by the laser and subsequently cooled. Sometimes sections of the part bend upwards into the path of the roller or scraper. This is one of the biggest problems with selective laser melting and often causes parts or even entire builds to fail.

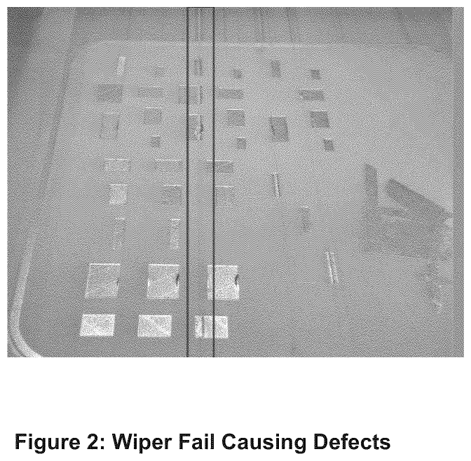

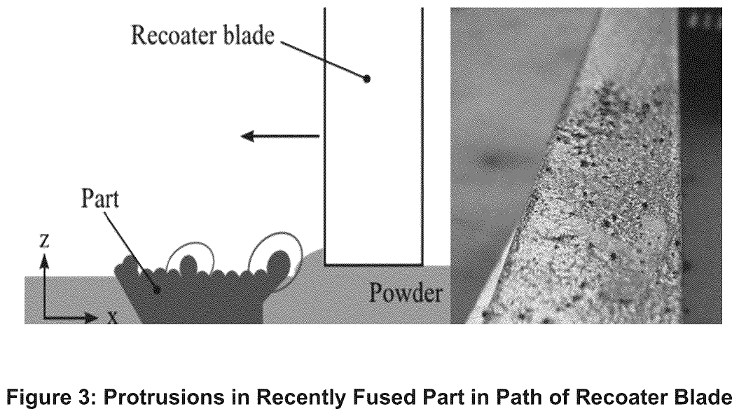

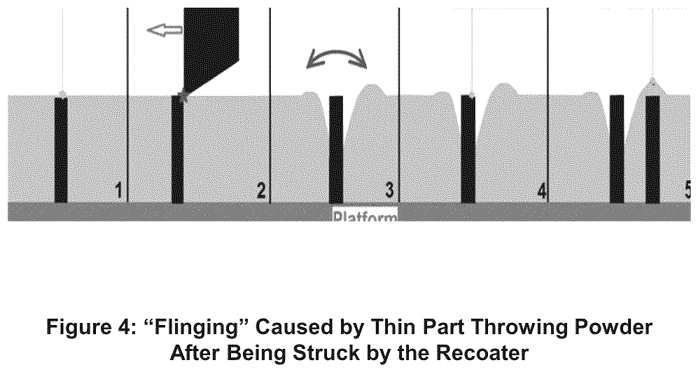

For example, FIG. 2 includes an image of a wiper fail causing part defects. Vertical lines indicate where the wiper has been damaged and is leaving streaks in the powder bed. This type of failure is very common. FIG. 3 illustrates how protrusions in a recently fused part can collide with the recoater blade. FIG. 4 illustrates how “flinging” can occur where a thin part will throw or fling powder after being struck by the recoater.

Continuing with an explanation of PBF recoater problems recognized herein. scrapers can be hard or soft. Hard scrapers are made from materials like tool steel to be more resistant to wear and damage. If the part warps into the path of a hard scraper, then the part will often be torn off the build plate or the scraper carriage may entirely stall, causing the build to fail. On the other hand, soft scrapers are made from soft materials like silicone or rubber. Soft scrapers are more prone to wear and need to be replaced often. If a part warps upward into the path of a soft scraper, usually a notch is worn into the soft scraper. This notch in the soft scraper will leave a stripe of powder over the build platform, which, in turn will cause defects in parts and potentially lead to the entire build to fail. Furthermore, wearing of the scraper introduces contaminants into the part. This contamination can drastically affect the part's material properties and part strength.

### Electrostatic Powder Leveling

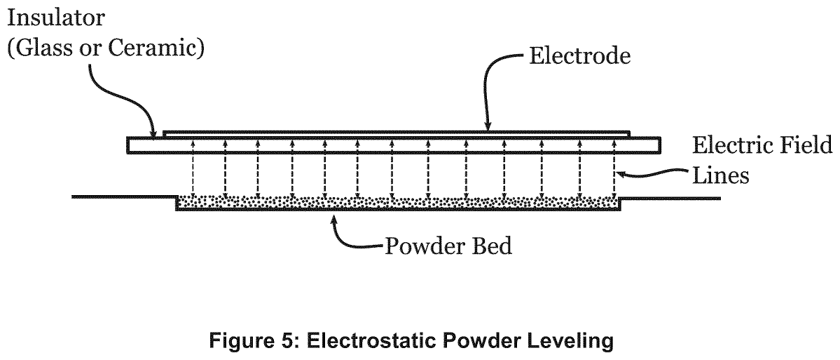

Electrostatic Powder Leveling examples are shown in FIGS. 5, 6, 7, and 8 of this application and are also disclosed in U.S. Pat. No. 11,612,940, which is incorporated by reference in its entirety. As disclosed in U.S. Pat. No. 11,612,940, a high-voltage alternating electric field can be used to planarize or level a powder bed to correct for defects left behind by a wiper or powder dispenser. By way of example only, an electrode may preferably be positioned about 2 millimeters (mm) above the powder bed. A high-voltage alternating-current signal (e.g., from about 1000V to about 5000V, etc.) may be applied between the electrode and the powder bed. An insulator/dielectric plate (e.g., glass, ceramic, etc.) may be placed between the electrode and the powder bed for preventing direct arcing. The trailing electrode with the high-voltage alternating electric field may be used to correct, e.g., for wiper defects, etc.

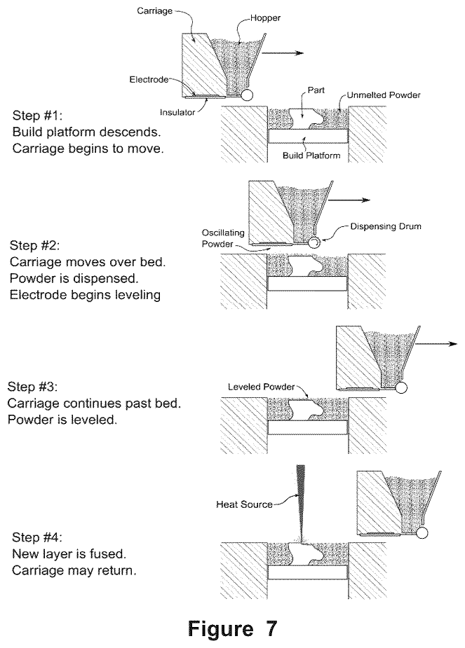

FIG. 7 illustrates an example process in which an electrode with an alternating electric field is used to create a level bed of powder. At the first step shown in FIG. 7, the build platform descends and the carriage begins to move. At the second step, the carriage moves over the bed, powder is dispensed from the hopper, and the electrode begins leveling the bed of powder. At the third step, the carriage continues moving past the powder bed, and the powder is leveled. At the fourth step, the new layer of powder is fused by the heat source, and the carriage may return to its initial or original starting position.

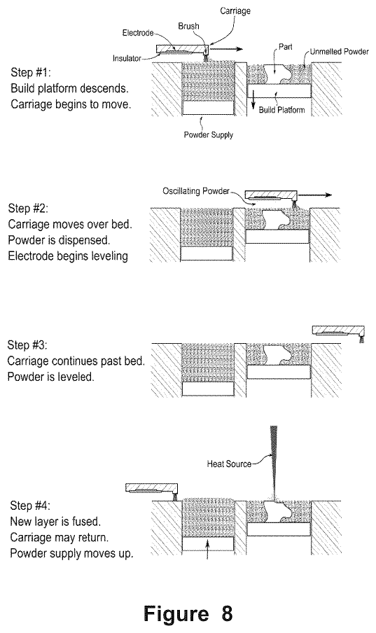

FIG. 8 illustrates an example process in which a wiper (e.g., a compliant or flexible wiper, etc.) is used to pre-spread powder onto the bed and then an electrode with an alternating electric field is used to correct defects left by the wiper and thereby create a level bed of powder. At the first step shown in FIG. 8. the build platform descends and the carriage begins to move. At the second step, the carriage moves over the bed, powder is dispensed from the powder supply, and the electrode begins leveling the bed of powder. At the third step, the carriage continues moving past the powder bed, and the powder is leveled. At the fourth step, the new layer of powder is fused by the beat source, the carriage may return to its initial or original starting position, and the powder supply moves up.

With reference to the example shown in FIG. 5, the electrode generates an electric field strong enough to cause the powder particles to rise toward the electrode and insulator (e.g., glass or ceramic, etc.). As the voltage on the electrode alternates, particles rise and fall between the powder bed and the insulator. Particles collide with each other and with the insulator as the particles oscillate. The collisions cause particles to tend to redistribute or move from regions of high powder concentration to lower powder concentration. In other words, powder tends to move from areas where the powder bed is higher to areas where the powder bed is lower, thus leveling the bed.

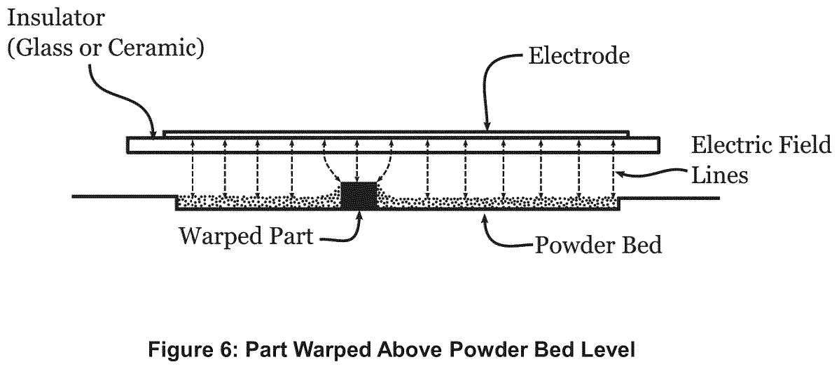

If there are solid pieces of material, for instance, a part warping above the powder bed level, the powder is leveled nearly the same as if the solid obstruction were not present. See the example shown in FIG. 6 in which a part has warped above the powder bed level.

### Exemplary Embodiments Including Non-Contact Powder Redistributors

After recognizing the above, exemplary embodiments of powder bed recoaters including non-contact powder redistributors were developed and/or are disclosed herein. Also disclosed herein are powder bed additive manufacturing systems including non-contact powder redistributors and methods for recoating powder beds. In exemplary embodiments, a pattern of powder is applied onto a previous layer such that the only a portion of the powder bed is covered with fresh powder. Thereafter, a non-contact redistributor (e.g., including an electrode with alternating electric field, gas jets, ultrasonic vibration, etc.) is moved (e.g., via a carriage, etc.) over the powder bed to flatten the powder bed. Because only a portion of the powder bed was patterned with the fresh powder, the powder is redistributed or moves from the high or higher locations defined by the newly added fresh powder to the low or lower locations when the powder bed is flattened. With this powder redistribution and flattening of the powder bed, the final height of the powder within the powder bed drops below the bottom of the carriage. This means a clearance distance can be maintained between the powder bed and the carriage.

As compared to a conventional drum dispenser, exemplary embodiments of the powder bed recoaters including the non-contact powder redistributors disclosed herein may provide one or more of (but not necessary any or all of) the following advantages. For example, there is intrinsically no problem with the powder bed height raising or lowering due to an incorrect amount of powder being dispensed. Powder simply fills the space between the carriage and the powder bed, whatever that may be. If the powder bed is too high, less powder is automatically or naturally dispensed. If the powder bed is too low, more powder is automatically or naturally dispensed. This self-correcting mechanism would certainly be appealing and appreciated for powder bed additive manufacturing systems. Exemplary embodiments disclosed herein also eliminate the need for overly complex and costly electronic feedback mechanisms to correct for a roller's inaccuracies. Exemplary embodiments disclosed herein do not require or have additional moving parts other than the carriage, and powder simply flows under the force of gravity.

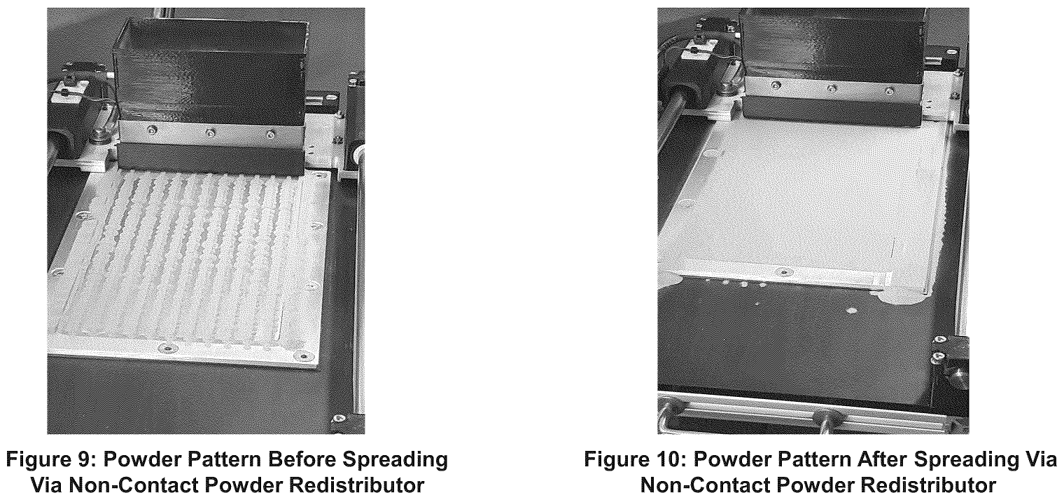

FIGS. 9 and 10 respectively show powder patterns before and after spreading or redistributing the powder in the powder bed via a non-contact powder redistributor (e.g., including an electrode with alternating electric field, gas jets, ultrasonic vibration, etc.) according to exemplary embodiments of the present disclosure. As shown in FIG. 9, the powder pattern includes or is defined by a series of powder stripes, strips, or ridges. In this example, the pattern is created by a series of evenly spaced holes (e.g., 2 mm diameter holes, etc.) in the bottom of the hopper. Powder flows out of the holes onto the substrate leaving stripes of powder. When the carriage returns and is moved back over the powder bed, the electrode is energized to produce an alternating electric field. As the electrode is moved along with the carriage over the pattern of powder, the alternating electric field causes the powder to redistribute from the higher locations along the powder stripes (e.g., along the upper portions or peaks of the powder stripes, etc.) to the to the lower locations between the powder stripes (e.g., gaps or valleys between the powder stripes, etc.) thereby leveling the powder stripes into a flat powder bed as shown in FIG. 10. In this example, the dispensing and the leveling action may be performed in a single motion or movement across the powder bed. Or the dispensing may occur in a first motion across the powder bed, and the leveling may occur in a second return motion across the powder bed in a direction opposite the first dispensing motion. In this exemplary embodiment, the non-contact powder redistributor included an electrode with an alternating electric field. In other exemplary embodiments, the non-contact powder redistributor may be configured differently, e.g., include one or more gas jets, ultrasonic vibration, etc.

As recognized herein, advantage(s) may be realized by creating an uneven powder bed (e.g., powder pattern with stripes (FIG. 9), etc.) that is relatively immediately flattened or leveled thereafter. More specifically, it is advantageous to always maintain a gap or clearance between the carriage and the powder bed so that any part protrusions in the powder bed (e.g., warped parts protruding upwardly beyond top of powder bed, etc.) do not collide with the recoater carriage. By only applying powder to parts of the powder bed, the carriage can maintain this gap or clearance. And when the powder is redistributed via a non-contact powder redistributor disclosed herein, the level of the powder bed is lower than the bottom of the carriage.

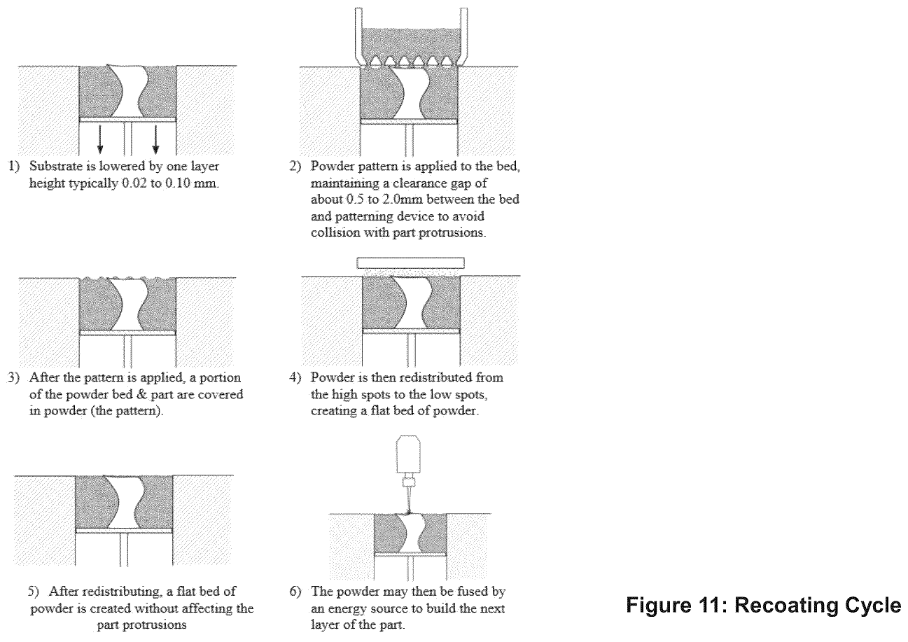

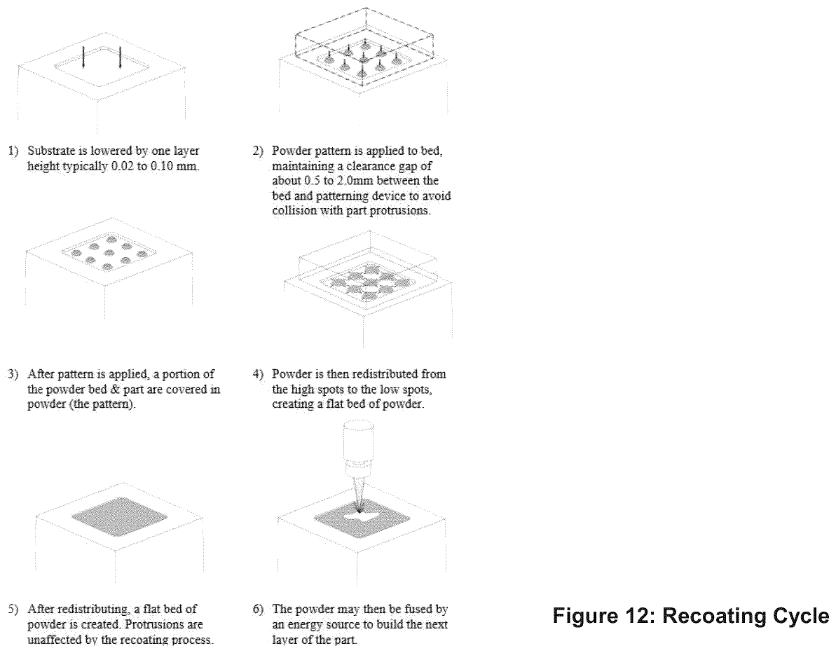

FIGS. 11 and 12 illustrate a recoating cycle and a front view of a part being built according to an exemplary embodiment of the present disclosure. As shown in FIGS. 11 and 12, the substrate is lowered by one layer height, e.g., typically about 0.02 mm to about 0.10 mm, etc. A powder pattern (e.g., powder stripes (FIG. 9), etc.) is applied to the powder bed while maintaining a clearance gap (e.g., of about 0.5 mm to about 2.0 mm, etc.) between the powder bed and patterning device (e.g., a powder hopper including holes spaced apart in the bottom of the hopper, etc.) to avoid collision with part protrusions. After the powder pattern is applied, a portion of the powder bed and the part are covered in the newly applied powder (covered by the powder pattern). Powder is then redistributed via a non-contact powder redistributor (e.g., including an electrode with alternating electric field, gas jets, ultrasonic vibration, etc.) from the high spots (e.g., along the upper portions or peaks of the powder stripes, etc.) to the low spots (e.g., gaps or valleys between the powder stripes, etc.) creating a flat bed of powder. After redistributing the powder via the non-contact powder redistributor, a flat bed of powder is created without affecting the part protrusions. The powder may then be fused by an energy source (e.g., laser, electron beam, etc.) to build the next layer of the part.

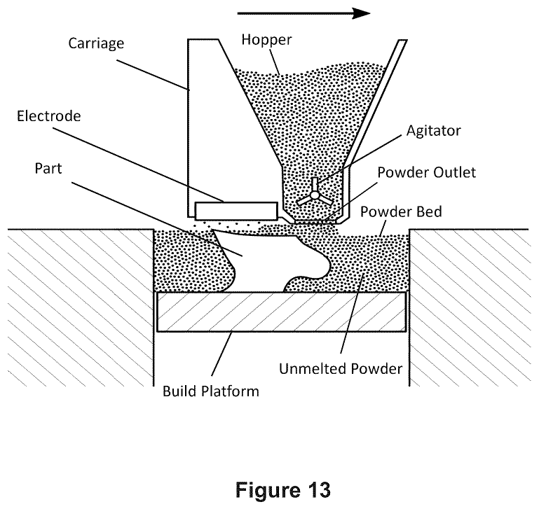

FIG. 13 illustrates a powder bed recoater including a non-contact powder redistributor comprising an electrode according to an exemplary embodiment of the present disclosure. The non-contact powder redistributor is configured to create an alternating electric field between the electrode and the powder bed for causing powder particles to redistribute from high spots to low spots to thereby flatten the powder bed.

As shown in FIG. 13, the powder patterning and leveling can be accomplished in a single pass across the powder bed. In this exemplary embodiment, the hopper and the electrode of the non-contact powder redistributor may be movable via a carriage over a top surface of the powder bed. As the carriage moves over the powder bed, powder may be applied in a pattern along the top of the powder bed via the powder outlet along the bottom of the hopper. Also as the carriage moves over the powder bed, the non-contact powder redistributor creates an alternating electric field between the trailing electrode and the powder bed for causing powder particles to redistribute from high spots of the powder pattern to low spots to thereby flatten the powder bed.

FIG. 13 also illustrates an agitator near the powder outlet on the bottom of the carriage. The agitator is configured to help keep the powder flowing smoothly out of the powder outlet onto the powder bed. Tests have revealed that the agitator is helpful when using sticky powder or powder that does not flow well.

The non-contact powder redistributors disclosed herein do not add or remove powder, so the total powder volume before and after powder redistributing is approximately the same. For exemplary embodiments with equally spaced powder outlets or openings along the bottom of the carriage, the powder pattern geometry is translationally invariant along the length of the carriage path. In this case, the relationship between the angle of repose θ, pattern width Wₚ, pattern spacing Wₛ, pattern height Hₚ and bed height H_{b} is shown is as follows:

$${H}_{b} {W}_{s} = {H}_{p} ( {W}_{p} + {H}_{p} {tan}^{- 1} θ )$$

Accordingly, exemplary embodiments are disclosed herein that include totally non-contact powder redistributors. As disclosed herein, a carriage containing powder is moved over a powder bed maintaining a clearance gap (e.g., about 0.2 to about 3.0 mm, etc.) between the bottom of the carriage and the top of the powder bed. Powder is allowed to flow out of the carriage through powder outlets or openings along the bottom of the carriage onto the top of the powder bed. The powder outlets or openings only cover a portion of the total powder bed surface area. Powder flows out of the powder outlets or openings and completely fills the clearance gap. At which point, more powder is prevented from flowing out of the powder outlets or openings after the clearance gap between the carriage and the powder bed is filled with powder. The above steps or processes create a pattern of powder on the powder bed where portions of the powder bed are now covered in fresh powder corresponding to the location of the powder outlets or openings along the bottom of the carriage. A non-contact powder redistributor (e.g., an electrode with an alternating electric field, gas jets, ultrasonic vibration, etc.) then flattens and spreads the powder pattern layer so that the powder layer is now spread evenly over the entire surface of the powder bed. When the powder pattern layer is spread/flattened, the top of the flattened layer of powder is now lower than the bottom of the carriage and a smooth layer of powder has been spread onto the powder bed while maintaining a clearance distance between the bottom of the carriage and the final height of the powder bed.

In some exemplary embodiments, the powder bed is a planar bed although this is not required for all embodiments, which may include a powder bed having a curved or undulating shape. In addition, the powder pattern is not limited to a series of powder stripes, strips, or ridges as shown in FIG. 9. as the powder pattern may be any shape or configuration that is preferably easily spreadable by the chosen redistribution mechanism (e.g., an electrode with an alternating electric field, gas jets, ultrasonic vibration, etc.).

In exemplary embodiments disclosed herein, the powder pattern comprises a series of powder stripes, strips, or ridges applied along the direction of travel of the recoater carriage. In this example, the hopper may include a series of equally spaced holes or slots (broadly, powder outlets) in the bottom of the hopper. Powder flows out of the holes as the carriage travels, leaving behind streaks of powder. Then, an electrode trailing behind the holes performs the leveling as disclosed herein. In some exemplary embodiments, a powder gating mechanism may be used for regulating the powder flowing out of the hopper. For example, the powder gating mechanism may be used for stopping powder from flowing out of the hopper to allow the carriage to be moved to make way for the powder redistributor and eventually the laser or other heat source.

Accordingly, disclosed herein are exemplary embodiments of powder bed recoaters including non-contact powder redistributors. Also disclosed are exemplary embodiments of powder bed additive manufacturing systems including non-contact powder redistributors and methods for recoating powder beds.

In exemplary embodiments, a system for recoating a powder bed comprises a non-contact powder redistributor configured to be operable for redistributing powder applied in a pattern along a top surface of the powder bed that covers only one or more portions, and not the entirety, of the powder bed, to thereby flatten or level the powder bed.

In exemplary embodiments, the non-contact powder redistributor comprises an electrode positionable over the powder bed, and a voltage supply configured to produce a high voltage alternating current signal for creating an alternating electric field between the electrode and the powder bed.

In exemplary embodiments, the voltage supply is configured to produce the high voltage alternating current signal to create the alternating electric field between the electrode and the powder bed for causing the powder in the pattern to redistribute to thereby flatten or level the powder bed without physically contacting the powder bed.

In exemplary embodiments, the system includes a non-conductive dielectric shield positionable over the powder bed between the electrode and the powder bed.

In exemplary embodiments, the voltage supply is configured to produce the high voltage alternating current signal to create the alternating electric field between the electrode and the powder bed for causing at least a top layer of powder particles in the pattern to oscillate in a region between the non-conductive dielectric shield and the powder bed and then reposition themselves on the powder bed.

In exemplary embodiments, the powder bed is electrically conductive and electrically grounded such that the powder bed is configured to form a lower electrode opposite the electrode for generating the alternating electric field between the electrode and the powder bed when the voltage supply is producing the high voltage alternating current signal.

In exemplary embodiments, the system includes a non-conductive dielectric plate or insulator positionable over the powder bed between the electrode and the powder bed whereat the non-conductive dielectric plate or insulator is operable to prevent direct arcing between the powder bed and the electrode.

In exemplary embodiments, the voltage supply is configured to produce the high voltage alternating current signal having a voltage amplitude ranging from about 300 volts to 5000 volts for creating an electric field strength between 150 to 2500 volts per millimeter between the electrode and the powder bed.

In exemplary embodiments, the system further comprises a carriage including one or more powder outlets along a bottom of the carriage. The carriage is movable over the top surface of the powder bed. The carriage is configured to be operable for dispensing powder through the one or more powder outlets in a pattern along the top surface of the powder bed that covers only one or more portions, and not the entirety, of the powder bed.

In exemplary embodiments, the one or more powder outlets comprise a plurality of spaced apart openings along the bottom of the carriage. And the carriage is configured to be operable for dispensing powder through the plurality of spaced apart openings along the bottom of the carriage as the carriage is moved over the top surface of the powder bed to thereby create a series of spaced apart stripes, strips, or ridges of the powder along the top surface of the powder bed in the direction of travel of the carriage across the powder bed.

In exemplary embodiments, the system is configured such that a clearance gap between the bottom of the carriage and the top of the powder bed is maintained as the carriage is moved over the powder bed.

In exemplary embodiments, the system is configured such that the powder is allowed to flow out of the one or more powder outlets along the bottom of the carriage until the powder completely fills the clearance gap between the bottom of the carriage and the top of the powder bed, thereby preventing further powder from being dispensed through the one or more powder outlets of the carriage.

In exemplary embodiments, the system is configured such that the powder is redistributed in the pattern to flatten the layer of powder such that the top of the flattened layer of powder is lower than the bottom of the carriage and a smooth layer of powder has been spread onto the powder bed while maintaining a clearance gap between the bottom of the carriage and the final height of the powder bed.

In exemplary embodiments, the non-contact powder redistributor comprises an electrode mounted on the carriage behind the one or more powder outlets.

In exemplary embodiments, the system further comprises an agitator near the one or more powder outlets. The agitator is configured to be operable for agitating the powder contained within the carriage near the one or more powder outlets before the powder is dispensed through the one or more powder outlets.

In exemplary embodiments, the non-contact powder redistributor comprises one or more gas jets or ultrasonic vibration generator.

In exemplary embodiments, the powder bed resides in a powder bed reservoir having one or more top edges. And the electrode is configured to be positioned over the powder bed in a downward motion and brought in contact with the one or more top edges of the powder bed reservoir before the voltage supply produces the high voltage alternating current signal.

In exemplary embodiments, the system includes a sensor configured to detect a level of capacitance between the electrode and the powder bed and to output an electric signal based upon the capacitance level detected. The system also includes a controller configured to receive the electric signal output by the sensor and to output a system adjustment signal based upon the received electric signal from the sensor.

In exemplary embodiments, the system includes an ammeter configured to measure a level of current flowing between the voltage supply and the electrode and to output an electric signal based upon the level of current measured. The system also includes a controller configured to receive the electric signal output by the ammeter and to output a system adjustment signal based upon the received electric signal from the ammeter.

In exemplary embodiments, a method comprises applying powder in a pattern along a top surface of a powder bed such that the applied powder covers only one or more portions, and not the entirety, of the powder bed. The method further comprises redistributing the powder in the pattern to flatten or level the powder bed without physically contacting the powder bed. The method may include using an alternating current to cause the powder in the pattern to redistribute to thereby flatten or level the powder bed without physically contacting the powder bed. Or the method may include using one or more gas jets or ultrasonic vibration to cause the powder in the pattern to redistribute to thereby flatten or level the powder bed without physically contacting the powder bed.

In exemplary embodiments, a method comprises applying powder in a pattern along a top surface of a powder bed such that the applied powder covers only one or more portions, and not the entirety, of the powder bed; and using an alternating current to cause the powder in the pattern to redistribute to thereby flatten or level the powder bed.

In exemplary embodiments, the method may include using a voltage supply to produce a high voltage alternating current signal for creating an alternating electric field between the powder bed and an electrode positioned over the powder bed for causing powder particles in the pattern to oscillate.

In exemplary embodiments, the method may include positioning the electrode and a non-conductive dielectric shield or insulator over the powder bed such that the non-conductive dielectric shield or insulator is between the electrode and the powder bed.

In exemplary embodiments, the method may include using the voltage supply to produce a high voltage alternating current signal having a voltage amplitude ranging from about 300 volts to 5000 volts for creating an electric field strength between 150 to 2500 volts per millimeter between the electrode and the powder bed.

In exemplary embodiments, the method may include dispensing powder through one or more powder outlets along a bottom of a carriage containing powder as the carriage is moved across the powder bed.

In exemplary embodiments, the one or more powder outlets may comprise a plurality of spaced apart openings along the bottom of the carriage. And the method may include dispensing powder through the plurality of spaced apart openings along the bottom of the carriage as the carriage is moved across the powder bed to thereby create a series of spaced apart stripes, strips, or ridges of the powder along the top surface of the powder bed in the direction of travel of the carriage across the powder bed.

In exemplary embodiments, the method may include dispensing powder from the one or more powder outlets along the bottom of the carriage containing powder as the carriage is moved over the powder bed while maintaining a clearance gap between the bottom of the carriage and the top of the powder bed. The powder may be allowed to flow out of the one or more powder outlets along the bottom of the carriage until the powder completely fills the clearance gap between the bottom of the carriage and the top of the powder bed, thereby preventing further powder from being dispensed from the one or more powder outlets of the carriage.

In exemplary embodiments, the method may include redistributing the powder in the pattern to flatten the layer of powder such that the top of the flattened layer of powder is lower than the bottom of the carriage and a smooth layer of powder has been spread onto the powder bed while maintaining a clearance gap between the bottom of the carriage and the final height of the powder bed.

In exemplary embodiments, the method may include agitating the powder contained within the carriage near the one or more powder outlets before dispensing the powder through the one or more powder outlets.

In exemplary embodiments, the method may include redistributing the powder in the pattern to spread the powder in the pattern such that the layer of powder is spread evenly over the entire surface of the powder bed.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for recoating a powder bed, the system comprising a non-contact powder redistributor configured to be operable for redistributing powder applied in a pattern along a top surface of the powder bed that covers only one or more portions, and not the entirety, of the powder bed, to thereby flatten or level the powder bed.

2. The system of claim 1, wherein the non-contact powder redistributor comprises:
an electrode positionable over the powder bed; and
a voltage supply configured to produce a high voltage alternating current signal for creating an alternating electric field between the electrode and the powder bed.

3. The system of claim 2, wherein the voltage supply is configured to produce the high voltage alternating current signal to create the alternating electric field between the electrode and the powder bed for causing the powder in the pattern to redistribute to thereby flatten or level the powder bed without physically contacting the powder bed.

4. The system of claim 2, wherein the system includes a non-conductive dielectric shield positionable over the powder bed between the electrode and the powder bed.

5. The system of claim 4, wherein the non-conductive dielectric shield comprises a non-conductive dielectric plate positionable over the powder bed between the electrode and the powder bed whereat the non-conductive dielectric plate is operable to prevent direct arcing between the powder bed and the electrode.

6. The system of claim 4, wherein the voltage supply is configured to produce the high voltage alternating current signal to create the alternating electric field between the electrode and the powder bed for causing at least a top layer of powder particles in the pattern to oscillate in a region between the non-conductive dielectric shield and the powder bed and then reposition themselves on the powder bed such that the top layer of powder particles is smoother than it was prior to when the powder particles began oscillating.

7. The system of claim 2, wherein the powder bed is electrically conductive and electrically grounded such that the powder bed is configured to form a lower electrode opposite the electrode for generating the alternating electric field between the electrode and the powder bed when the voltage supply is producing the high voltage alternating current signal.

8. The system of claim 2, wherein the voltage supply is configured to produce the high voltage alternating current signal having a voltage amplitude ranging from about 300 volts to 5000volts for creating an electric field strength between 150 to 2500 volts per millimeter between the electrode and the powder bed.

9. The system of claim 1, further comprising a carriage including one or more powder outlets along a bottom of the carriage, wherein the carriage is movable over the top surface of the powder bed and configured to be operable for dispensing powder through the one or more powder outlets in a pattern along the top surface of the powder bed that covers only one or more portions, and not the entirety, of the powder bed.

10. The system of claim 9, wherein:
the one or more powder outlets comprise a plurality of spaced apart openings along the bottom of the carriage; and
the carriage is configured to be operable for dispensing powder through the plurality of spaced apart openings along the bottom of the carriage as the carriage is moved over the top surface of the powder bed to thereby create a series of spaced apart stripes of the powder along the top surface of the powder bed in the direction of travel of the carriage across the powder bed.

11. The system of claim 9, wherein the system is configured such that a clearance gap between the bottom of the carriage and the top of the powder bed is maintained as the carriage is moved over the powder bed.

12. The system of claim 11, wherein the system is configured such that the powder is allowed to flow out of the one or more powder outlets along the bottom of the carriage until the powder completely fills the clearance gap between the bottom of the carriage and the top of the powder bed, thereby preventing further powder from being dispensed through the one or more powder outlets of the carriage.

13. The system of claim 9, wherein the system is configured such that the powder is redistributed in the pattern to flatten the layer of powder such that the top of the flattened layer of powder is lower than the bottom of the carriage and a smooth layer of powder has been spread onto the powder bed while maintaining a clearance gap between the bottom of the carriage and the final height of the powder bed.

14. The system of claim 9, wherein the non-contact powder redistributor comprises an electrode mounted on the carriage behind the one or more powder outlets.

15. The system of claim 9, further comprising an agitator near the one or more powder outlets, the agitator configured to be operable for agitating the powder contained within the carriage near the one or more powder outlets before the powder is dispensed through the one or more powder outlets.

16. The system of claim 1, wherein the non-contact powder redistributor comprises one or more gas jets and/or an ultrasonic vibration generator.

17. A powder bed additive manufacturing system comprising the system for recoating a powder bed of claim 1.

18. A method comprising applying powder in a pattern along a top surface of a powder bed such that the applied powder covers only one or more portions, and not the entirety, of the powder bed, wherein the method further includes:
using an alternating current to cause the powder in the pattern to redistribute to thereby flatten or level the powder bed; and/or
redistributing the powder in the pattern to flatten or level the powder bed without physically contacting the powder bed.

19. The method of claim 18, wherein the method includes redistributing the powder in the pattern by using one or more gas jets and/or ultrasonic vibration to cause the powder in the pattern to redistribute to thereby flatten or level the powder bed without physically contacting the powder bed.

20. The method of claim 18, wherein redistributing the powder in the pattern comprises using an alternating current to cause the powder in the pattern to redistribute to thereby flatten or level the powder bed without physically contacting the powder bed.

21. The method of claim 18, wherein the method includes using a voltage supply to produce a high voltage alternating current signal for creating an alternating electric field between the powder bed and an electrode positioned over the powder bed for causing powder particles in the pattern to oscillate.

22. The method of claim 21, wherein the method includes positioning the electrode and a non-conductive dielectric shield over the powder bed such that the non-conductive dielectric shield is between the electrode and the powder bed.

23. The method of claim 21, wherein using a voltage supply to produce a high voltage alternating current signal for creating an alternating electric field comprises using the voltage supply to produce a high voltage alternating current signal having a voltage amplitude ranging from about 300 volts to 5000 volts for creating an electric field strength between 150 to 2500 volts per millimeter between the electrode and the powder bed.

24. The method of claim 18, wherein applying powder in a pattern comprises dispensing powder through one or more powder outlets along a bottom of a carriage containing powder as the carriage is moved across the powder bed.

25. The method of claim 24, wherein:
the one or more powder outlets comprise a plurality of spaced apart openings along the bottom of the carriage; and
dispensing powder through the one or more powder outlets along the bottom of the carriage comprises dispensing powder through the plurality of spaced apart openings along the bottom of the carriage as the carriage is moved across the powder bed to thereby create a series of spaced apart stripes of the powder along the top surface of the powder bed in the direction of travel of the carriage across the powder bed.

26. The method of claim 24, wherein the method includes dispensing powder from the one or more powder outlets along the bottom of the carriage containing powder as the carriage is moved over the powder bed while maintaining a clearance gap between the bottom of the carriage and the top of the powder bed.

27. The method of claim 26, wherein the powder is allowed to flow out of the one or more powder outlets along the bottom of the carriage until the powder completely fills the clearance gap between the bottom of the carriage and the top of the powder bed, thereby preventing further powder from being dispensed from the one or more powder outlets of the carriage.

28. The method of claim 24, wherein the method includes redistributing the powder in the pattern to flatten the layer of powder such that the top of the flattened layer of powder is lower than the bottom of the carriage and a smooth layer of powder has been spread onto the powder bed while maintaining a clearance gap between the bottom of the carriage and the final height of the powder bed.

29. The method of claim 24, further comprising agitating the powder contained within the carriage near the one or more powder outlets before dispensing the powder through the one or more powder outlets.

30. The method of claim 18, wherein the method includes redistributing the powder in the pattern to spread the powder in the pattern such that the layer of powder is spread evenly over the entire surface of the powder bed.
